(19) United States
(12) Patent Application Publication
(10) Pub. No.: US 2006/0077361 A1
(43) Pub. Date: Apr. 13, 2006

(54) Means of removing particles from a membrane mask in a vacuum

(76) Inventor: Michael Sogard, Menlo Park, CA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/960,953

(22) Filed: Oct. 12, 2004

(51) Int. Cl. G03B 27/52

(52) U.S. Cl. 355/30; 355/75; 356/337

(57) ABSTRACT

A method of removing particles from a membrane reticle by a laser beam or beams. The particles on the bottom of the reticle are knocked off and fall away and particles on the top are removed a short distance from the surface and deposited on or near the strut wall and then released. Alternatively, the particles are dragged or rolled to the vicinity of the strut wall.

### BACKGROUND OF THE INVENTION

1. Field of the Invention

The present invention generally relates to an Electron Beam Projection Lithography System (EPL) and, more particularly, to cleaning a membrane reticle in an Electron Beam Projection System from contamination particles by using a laser beam.

2. Background Description

Lithography is an important method used in the electronic industry for fabricating circuit chips. Recently, electron beam projection lithography (EPL) exposure systems have been developed which are expected to offer high resolution and enhanced throughput. This system directs a relatively large area electron beam onto a portion (“subfield”) of a reticle containing the pattern associated with a specific process step for a semiconductor device. The electron beam transmitted through the reticle is projected onto a wafer where it forms a demagnified image of the illuminated part of the reticle. The reticle and wafer are mounted on precision high speed stages. By a combination of stage movement and electromagnetic deflection of the electron beam, the entire pattern on the reticle is sequentially transferred to the wafer where it exposes an electron sensitive resist. After exposure, the resist on the wafer is developed, and regions of the resist exposed by the electrons are removed, for a positive type resist; or regions of the resist not exposed by the electrons are removed, for a negative type resist. The remaining resist forms a stencil mask, with which the mask features can be transferred into the wafer by etching or deposition processes.

The EPL reticle is formed from a silicon wafer and consists of patterned subfields bordered by struts which provide mechanical support. The supporting struts are needed because the subfield regions consist of very thin membranes. In one type of EPL reticle the subfield patterning is provided by stencil openings in a membrane several microns thick. In another kind a continuous membrane approximately 150 nm or less in thickness supports patterned regions of thin metal layers in the subfield region. Electrons scattering in the thick membrane of the stencil reticle, or in the metal film regions of the continuous membrane reticle, are removed from the electron beam by a contrast aperture located at an electron optical crossover in the electron optics separating the reticle and wafer, thereby providing image contrast at the wafer. A narrow unpatterned “skirt” region of the membrane separates the patterned regions of each subfield from the edges of the adjacent struts.

Particles which accidentally land on the reticle can distort the image of the reticle pattern on the wafer, leading to loss of semiconductor device yield. This is a common problem in lithography. To prevent this, in photolithography, a very thin optically transparent film, called a pellicle, is suspended over the reticle patterned surface. The distance between the reticle and pellicle far exceeds the depth of focus of the optical projection lens at the reticle, so any particle attached to the pellicle will project an image onto the wafer so diffuse that it will not print when the resist is developed. Applying a pellicle to an EPL reticle is problematic however. First, no electron optically transparent material exists; the pellicle would scatter the electron beam and reduce image contrast. A pellicle thin enough to limit electron scattering to an acceptable level would not be physically strong enough to extend across the reticle unsupported. In addition, the very large depth of focus of the electron beam would require the pellicle to be very far from the reticle, up to perhaps several centimeters. Thus the reticle would become very bulky and might seriously compromise the electron optics design. Although the high energy electrons in EPL will probably not be influenced as strongly by particle contamination as would photons, particle contamination is still considered a serious problem. While the reticle is stored in a particle free cassette, it must be removed from the cassette (in vacuum) when loaded onto the EPL reticle stage. No means of protecting the reticle at that point from particles which might adhere to it during loading or exposure is known. Further, no cleaning techniques for removing such particles in situ from a reticle are known.

It may be possible to use radiation forces from a laser beam or beams to remove some particles from the reticle subfields. Light, as a carrier of momentum, exerts pressure which can be used to accelerate particles. Using highly focused laser radiation, microparticles on a reticle can be optically attracted to and confined within the neighborhood of the focal volume by the radiation forces. The possibility of laser trapping of microparticles using the radiation force of light was discovered by Ashkin in 1970. The laser trapping technology makes it possible to lift a microparticle against gravity and trap it. Additionally, this technique permits non-contact manipulation of the microparticles by scanning the laser beam or moving the object to be cleaned under the beam. The obvious advantages of the method are that no mechanical contact and no perturbations of the physical and chemical conditions of a sample are required. This phenomenon is the basis for optical levitation and manipulation of particles by so-called “optical tweezers”. Optical tweezers, also known as single beam gradient force optical traps, are based on piconewton level force generation during the interaction of a highly focused laser beam with dielectric particles, including cells and organelles.

The radiation forces are of two types. One is a classical radiation pressure from momentum transfer of photons reflected from the particle surface or absorbed within it. In addition, if the particle is transparent, additional force comes from photons which refract through the particle. The photons may be multiply reflected within the particle as well. These photons generate a force in the direction of the gradient of the light intensity. For example, for the common case of a gaussian laser beam, the gradient force points toward the waist of the beam if the particle is on axis. If the particle is off-axis, there is an additional lateral force which pushes the particle toward the axis. Thus a single strongly focused gaussian beam can function like a particle trap, confining the particle to a small volume within the beam. Levitation has been demonstrated for both small dielectric and small metallic particles.

The U.S. Pat. No. 5,212,382 to Sasaki et al. also discloses a laser trapping system which provides for trapping a microparticle with low index of refraction (index less than 1.0) or a photoreflective microparticle. This situation can describe metallic particles. This invention teaches laser trapping by scanning at least a focused laser beam at a high speed and trapping a micropaticle or a group of microparticles in a given space pattern. Alternatively, such particles may be trapped within a small volume surrounding the gaussian waist of the laser beam, if the beam is generated by a laser oscillating in a TM01 mode or by a laser beam containing a dark optical vortex such as described in K. Gahagan et al, Optical Vortex Trapping of Particles, Optics Letters Vol. 21, 827(1996). Such a beam is characterized by having a very low intensity along the propagation axis, with the intensity increasing laterally until finally it drops off again. Within the central region of the beam, a metallic particle is repelled by the surrounding higher intensity regions and thus is trapped. However, for particle sizes which are small compared to the wavelength of the laser light, metallic as well as non-metallic particles can be effectively trapped in a conventional focused laser beam. In fact, as shown in K. Svoboda et al, Optical Trapping of Metallic Rayleigh Particles, Optics Letters Vol. 19, 930(1994), gold particles of diameter 40 nm are trapped with approximately seven times the strength as non-metallic particles. Thus both dielectric and metallic particles may be trapped and removed by focused laser beams with appropriate properties. The removed particles can then be disposed of or relocated on the reticle subfields to non-critical areas such as the skirt.

In addition to levitating the particle, the laser force must be strong enough to overcome the adhesive forces binding the particle to the reticle membrane. The Japanese paper Sasaki et al., In Situ Measurement of Adhesion Force between a Single Microparticle and a Surface Using Radiation Pressure of Pulsed Laser Light (Jap. J. Appl. Phys. 36, L721 (1997) describes a usage of radiation pressure from a Q-switched laser to successfully remove adsorbed particles from a glass plate, thereby measuring directly the adhesive force. It is clear that radiation pressure created by a laser is sufficient to remove at least some particles.

Particle adhesion arises from bonds between molecules or atoms in the particle and molecules or atoms in the reticle membrane. In order to remove the particle from the surface, all of these bonds must be broken. However if the particle can be forced to roll or tumble on the surface, by means of lateral forces such as those from the intensity gradients of a laser beam, only a fraction of those bonds must be broken at a given moment. As the particle rolls on the surface, bonds at the trailing edge are broken; but simultaneously new bonds at the leading edge are formed, so the net force required to roll the particle should be a small fraction of that required to remove the particle. A similar argument may be applied to a particle which slides on the surface. This is an alternative mechanism which can remove particles from patterned regions of a subfield and deposit them in a non-critical region like the skirt.

Particles may also be removed from a reticle by vibration of the mask. This method is effective, if the peak force on the particle achieved during the vibration exceeds the adhesive force binding the particle to the membrane. In practice, this method is usually carried out with the reticle immersed in a fluid. The vibrations are conveyed to the fluid and its momentum contributes to the removing forces.

### SUMMARY OF THE INVENTION

It is therefore an aim of the present invention to provide a method for cleaning a membrane reticle from particulate contamination in a vacuum environment by a laser beam.

According to the present invention the removal of the particles can be done off-line, before the reticle is exposed to the electron beam, or, if the cleaning process is fast enough, it might be possible to clean each reticle subfield with an off-axis (relative to the electron beam) laser beam or beams shortly before the subfield is exposed. In the first case, particles on the bottom of the reticle are knocked off and fall away; particles on the top are removed a short distance from the surface and deposited on the struts or the skirt surrounding the subfield patterned areas. According to another approach particles are lifted high enough to clear the strut wall and are then released after the reticle has been moved away. The latter requires substantially more laser power and is probably much slower. In another situation the laser forces are too weak to remove all the particles from the membrane, but strong enough to roll or slide the particles to the subfield periphery. Mechanical vibration of the reticle during the cleaning process may assist in particle removal. In all cases the laser beam is smaller than the subfield and must be scanned over the subfield to cover the entire area. Some of the scanning could be mechanical, coming from motion of the reticle stage.

It also should be noted that the membrane is made of silicon, which is quite transparent for a laser wavelength slightly greater than 1 μm. This means that the membrane absorbs very little of the laser energy, and quite high laser intensities could be used without heating the membrane appreciably. A suitable laser for this application might be a NdYAG laser with a wavelength of approximately 1.06 μm. Alternatively, a limited amount of heating of the membrane may assist in freeing a particle for lateral motion.

The present invention can be also applied to an optical lithography reticle, which is not otherwise protected by a pellicle, such as an F2 lithography reticle.

Additionally, the present invention provides a vibration during application of the laser beams. In the present invention a vibration of the reticle would add to the maximum force applied to the particle, and so particle removal would be enhanced. The advantage of combining these techniques is that the vibration assists the laser in removing the particle. However the particle is then trapped by the laser beam and/or safely conveyed away. There is little possibility of the particle re-adhering to the membrane somewhere else in an uncontrolled way.

According to the invention, there is provided a method of cleaning a membrane reticle of an Electron Beam Projection Lithography system by means of a laser beam.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1A-1D show the approaches of using radiation forces to clean particles off the reticle of Electron Beam Projection System;

FIGS. 2A-2B show another procedure of removing particles from the reticle;

FIG. 3 shows the index of refraction and extinction coefficient for silicon;

FIG. 4 shows a side view of the reticle subfield and strut;

FIG. 5 shows how a larger Numerical Aperture beam could be used, if its axis swing as the beam sweeps across the subfield;

FIG. 6 shows a high Numerical Aperture levitation beam entering the reticle membrane from below;

FIGS. 7A-7B show embodiments of the invention appropriate to a continuous membrane type reticle or a conventional optical lithography mask;

FIG. 8 shows an embodiment which conveys the laser light to the vicinity of the reticle by means of an optical fiber;

FIG. 9 shows another embodiment of the invention which enables a number of reticle subfields to be cleaned simultaneously;

FIG. 10 shows an embodiment where vibration of the reticle is used to enhance particle removal.

FIG. 11 shows an embodiment wherein the claimed method can be used in the lithography machine.

### DETAILED DESCRIPTION OF A PREFERRED EMBODIMENT OF THE INVENTION

The most effective way to clean particles from a reticle is to apply optical levitation forces to remove the particles. Specifically, a combination of radiation pressure and laser gradient forces seems best suited for this application. In order to be effective, the laser forces must be greater than the reticle-particle adhesive forces. However, taking account of the wide nature and physics of adhesive forces, it is difficult to determine a “typical” adhesive force.

By focusing a single laser beam with a high numerical aperture (NA) objective lens, a gradient field of light intensity is created with high intensity values in the focal volume and lower in the periphery. If the interaction with a particle is primarily determined by beam refraction and when the absorption is negligible, the net force acts toward the focal volume. The net force (trapping force) can be used to “pull” and to confine micro- and nanometer-sized objects in the focal volume. Additionally, a radiation pressure force pushes the particle along the propagation direction of the laser beam.

When using a highly focused continuous laser beam, really small particles can be optically trapped and can be manipulated in three dimensions without physically touching them. In particular, contact-free particle transport can be performed by moving the focal volume of the laser beam in the desired direction.

Typical laser sources for optical trapping are the Nd:YAG laser at approximately 1.06 μm and semiconductor laser diodes. Often, the laser beam is coupled by light fibers to a diffraction-limited spot by objective lenses with numerical aperture NA<1.

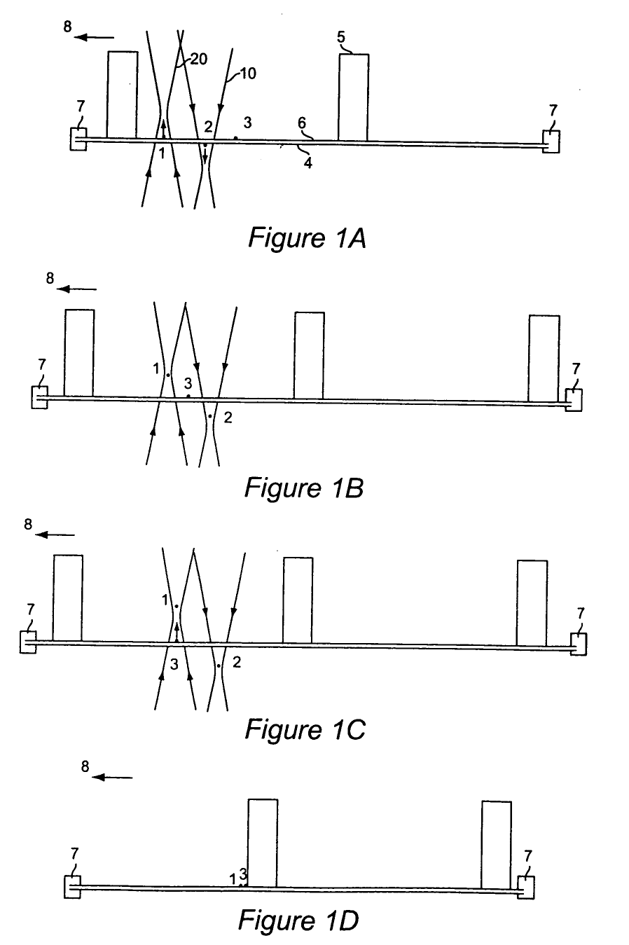

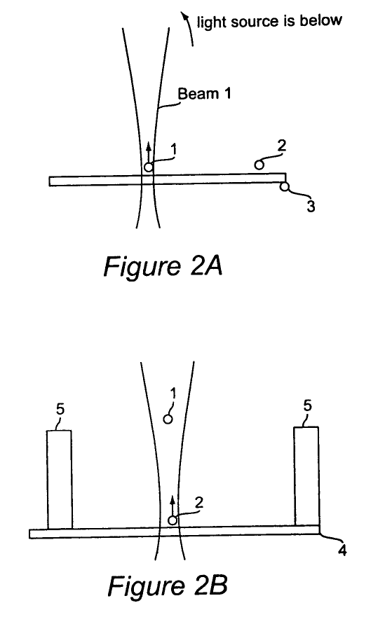

Referring now to the drawings, and more particularly to FIGS. 1A-1D, there are shown some particular operations for using the radiation pressure to clean particles off the reticle in accordance with a preferred embodiment of the invention. This could be done off-line, before the reticle is exposed to the electron beam, or, if the cleaning process is fast enough, it might be possible to clean each reticle subfield with an off-axis (relative to the electron beam) laser beam shortly before the subfield is exposed. This mode of operation would provide continuous cleaning of the reticle as long as it is in use. In these figures a laser beam 10 propagates downward and is focused just below the membrane 4 fixed stationary in membrane holder 7. A second laser beam 20 propagates upward and is focused just above the membrane. In FIGS. 1A-1D the particle is assumed to be dielectric. FIGS. 1A-1C show that particle 2 on the bottom of the reticle is removed by membrane mover 8 a short distance from the membrane while particles 1 and 3 on the top are removed a short distance above the surface. FIG. 1D shows the particles 1 and 3 deposited on a subfield strut 5 or on the membrane skirt 6. Particle 2 is released and falls away when the laser beam 10 is turned off when it nears the strut 5. The radiation conditions may be such that, alternatively, particle 2 falls away from the membrane after being detached. In another embodiment the particles are lifted high enough to clear the strut wall and are then released after the reticle has been moved away. This removal of the particles is shown in FIGS. 2A and 2 B. The latter requires substantially more laser power and is probably much slower. In both applications the laser beam is smaller than the subfield and must be scanned over the subfield to cover the entire area. Some of the scanning could be mechanical, coming from motion of the reticle stage. The laser beams are turned off as their focal regions approach a strut, to avoid unnecessary heating of the reticle.

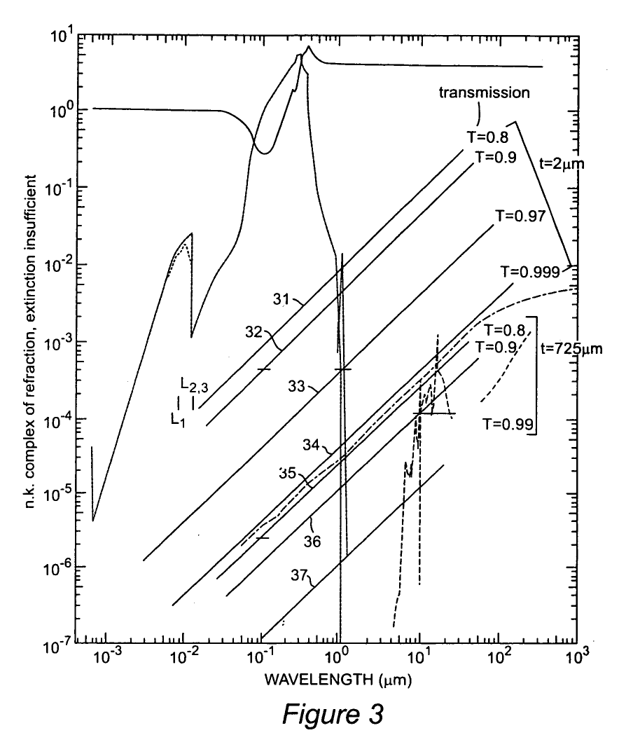

It should be noted that the present invention particularly deals with silicon reticle cleaning. FIG. 3 shows the index of refraction (n) and extinction coefficient (k) for silicon. k is defined from the relation describing transmission T(t) of radiation of wavelength λ through a silicon slab of thickness t:
T(t)=exp[−4πt/λ].

Solving this expression for k gives
k=−λ/4πln[T(t)]

This expression is plotted (lines 31-37) in FIG. 3 for a number of values of transmission and for thickness of 2 μm, representing the reticle membrane, and for 725 μm, representing the thickness of the struts. The intersection of these lines with that of the extinction factor k for silicon, or a semiconductor diode laser with a wavelength slightly greater than 1 μm. For slightly longer wavelengths, comparable transmissions even in the struts appear possible, so the laser may not even have to be turned off as it crosses over a strut. FIG. 3 shows that silicon maintains a very high degree of transparency to radiation with wavelengths extending from slightly more than 1 μm to greater than 5 μm. Lasers operating within this wavelength range would thus be suitable for this application. Of course light sources with wavelengths shorter than 1 μm or longer than 5 μm could also be used, although their maximum allowable intensities at the membrane might have to be reduced.

The admitted prior art shows that laser peak intensities of the order of 10⁷ W/cm² are needed to remove particles of the order of 10 μm or more in diameter. However, the required intensity decreases with particle size.

Generally, the estimated net optical levitation force (trapping force, F) on a spherical particle depends linearly on the laser power P directed on the particle and can be represented by: F=QP/c, where c is the velocity of light in the medium, and Q is the trapping efficiency parameter with values typically between 0 and 2. The parameter Q depends on the optical properties of the trapped object, such as the refractive index, in addition to its shape, and on the beam profile and alignment. The knowledge of the trapping parameter allows the calculation of the trapping force. Q can be calculated theoretically in the case of spherical particles with known refractive index.

For example, for a NdYAG laser with wavelength λ=1.064 μm, total beam power of 10 W, and numerical aperture NA=0.09 the illumination spot size or diameter of the laser beam waist is approximately d=λ/NA=3.87 μm. The peak intensity is 4.25×10⁷ W/cm². For the case of a spherical silicon (n=3.6) particle of radius 0.5 μm and centered on the beam near its waist, the trapping efficiency is Q=1.58, and the trapping force is given approximately by F_{light}=1.73292×10⁻⁹ N. The corresponding gravitational force on the particle is F_{grav}=1.19559×10⁻¹⁴ N, leading to the relation F_{light}/F_{grav}=145088.

Thus the laser force on a particle can be substantial. However, the beam spot size is small and in order to cover larger areas on the reticle, it may be more effective to use a relatively highly focused, intense beam, possibly pulsed, to “break loose” the particles from the membrane, and then use a much bigger, but lower intensity, beam to levitate the freed particles until they are swept away from the patterned subfield. According to above calculation the peak force on a 1 μm particle from radiation pressure accelerates the particle at approximately 10⁵ g where g is the acceleration of gravity. Clearly a much weaker beam intensity would be sufficient to levitate the freed particle.

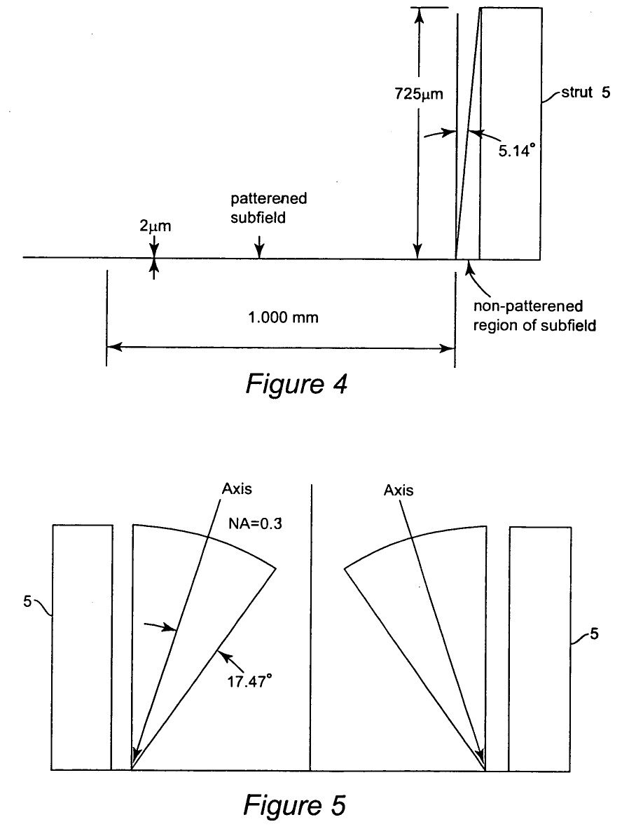

FIG. 4 shows a side view of the reticle subfield and strut. Because of the high strut wall, a laser beam focused on the edge of the subfield pattern would have to be fairly narrow. The angle shown of 5.14° corresponds to a numerical aperture of approximately 0.1. A large numerical aperture is desirable to focus the laser beam to a fine spot and generate strong gradient light forces.

FIG. 5 shows how a larger NA beam could be used, if its axis swings as the beam sweeps across the subfield.

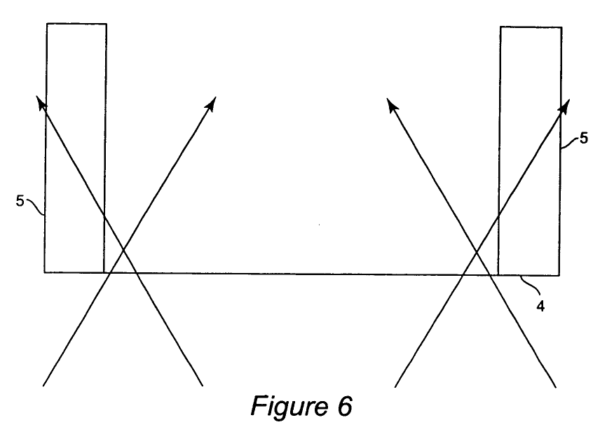

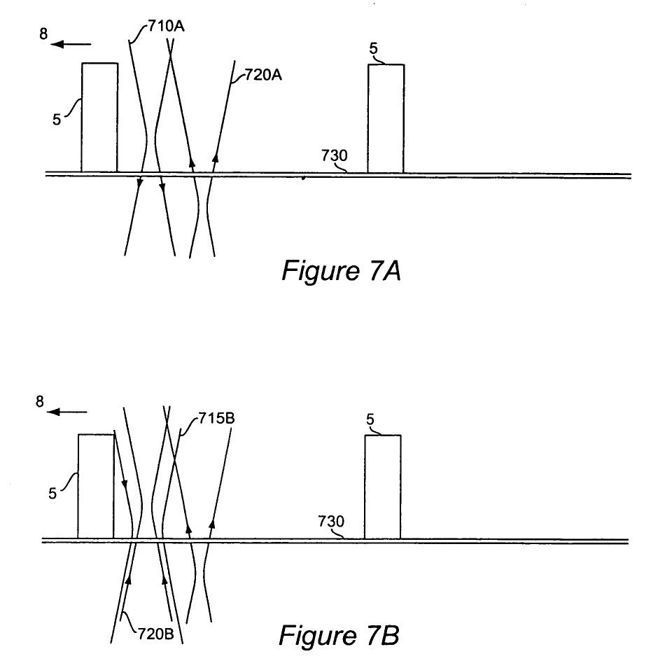

FIG. 6 shows a high NA levitating beam entering the reticle membrane from below. Some fraction of the beam is absorbed by the struts above the particle trapping region, but if the absorption is low enough this may not be a problem. Since the particles are levitated below the plane of intersection of the beam with the strut wall, they are not affected by this.

Additional comments should be made about conditions wherein this invention should work. This application is assumed to take place within the vacuum environment of the EPL tool or in another vacuum chamber. This adds a complication to the process which has both advantages and disadvantages. The disadvantage is that in a vacuum, there are no dissipative forces present which cause drag and damp out motion of the freed particles. Therefore, the particle oscillates within the trapping volume created by the gradient forces of the laser beam, and after each oscillation period it returns to the surface it was removed from, where it may reattach. If the laser force is sufficiently strong this reattachment will presumably only be transient and should pose no problem. However, if the surface of membrane is inhomogenous, some regions may have a greater affinity for the particle, and the particle may become stuck there.

There are several measures to reduce the likelihood of this happening. The forces binding the particle to the reticle have a very short range. If the reticle is slowly moved further from the laser waist, or vice versa, so that the distance from the reticle to the center of the gradient trap increases, the particle will not quite reach the membrane on its return path, and its probability of reattaching will be reduced. This movement will also reduce the magnitude of the gradient force at the membrane. However, the radiation force decreases much less rapidly, so if it is comparable in size to the gradient force, particle removal efficiency may be largely unaffected. One could also increase the laser intensity simultaneously, so that the particle removal force is unaffected.

Another measure is to minimize the number of times the particle returns to the membrane surface. This means moving the particle to the skirt or struts surrounding the patterned area on the reticle membrane as quickly as possible. In conventional applications in air or liquid, the transverse motion of a trapped particle is limited by the dissipative forces mentioned above, which are proportional to the particle's relative velocity. These forces are absent in vacuum, so the particle's transverse velocity is limited only by the maximum acceleration the particle can undergo without being lost from the gradient trap. The gradient forces transverse to the direction of the laser beam can be even stronger than the axial gradient force, so the particle can be moved very quickly to the margin of the subfield.

One skilled in the art could also apply this cleaning method in a gas filled chamber, in which case viscous drag would keep the particle from reattaching. However, cleaning in vacuum is preferred, since the processes of introducing the reticle into a chamber, admitting gas, cleaning the reticle, pumping out the gas, and removing the reticle, may introduce more particles, or redistribute the particles on the reticle.

Another mechanism may assist in particle removal. Particles can typically move over a surface far more easily than they can be removed. The energy required to remove the particle is much greater. The force binding the particle to a surface arises from the sum of the binding forces between many individual atoms in the particle surface and the membrane surface. Removing the particle requires breaking all of these bonds essentially simultaneously. If a particle moves across a surface however, only a fraction of the bonds is broken at any instant, and a comparable number of new bonds is formed at the new particle location, so the net force required to move the particle is much smaller than the force required to remove it.

Since the transverse gradient force of the laser beam can be even stronger than the axial force, it should possible to move the particle along the surface of the membrane, even in cases where the axial gradient force is unable to remove the particle from the surface. If the membrane absorbs a fraction of the laser energy, so that its local temperature increases, this movement is enhanced further. For an unpatterned membrane this mechanism may prove to be very effective in moving particles to the periphery of the subfield. Yet if the reticle is a stencil with holes in the membrane defining the pattern, a particle may be pushed to the edge of one of these holes, which will block further progress by this mechanism. Since less of the particle is in contact with the surface at the edge, the binding force will be weaker, and removal of the particle from the surface is more likely.

Most of the above comments apply to the stencil type membrane reticle. The continuous membrane reticle with metal patterns has a problem in that the metal film is thick enough to substantially weaken the transmitted laser beam. Thus a particle which has been successfully freed from the surface and levitated by a laser beam passing through the membrane can settle back onto the membrane when a metal pattern interrupts part of the beam. FIGS. 7A and 7B describe embodiments to overcome this effect. In FIG. 7A the laser beams 710A and 720A are focused close to the incident sides of the membrane, so the trapping laser beam is not interrupted by the metal pattern 730. Since the force from the radiation pressure now opposes the gradient force, the net removal force is intrinsically weaker in this embodiment. In FIG. 7B an intense highly focused beam 720B is focused like the beams shown in FIGS. 1A-D, so that the radiation pressure force and the gradient force are in the same direction, and the removal force is maximized. A second weaker, less focused beam 715B opposes the first beam. Its focal position is adjusted to provide a gradient force in the same direction as the first beam. The gradient force of the second beam need be only strong enough to levitate the particle against gravity. Thus the first beam frees the particle from the membrane, and it is levitated by both beams. However when the first beam is interrupted by a metal pattern, the particle remains suspended by the second beam.

This last embodiment could be used to protect a conventional optical lithography mask which consists of patterns composed of metal and/or dielectric films deposited on a transparent substrate. While pellicles are normally used to protect such masks, pellicles for very short exposure wavelengths such as 157 nm have not yet proven completely satisfactory, so an alternative protection means is worth considering.

Since particles on the reticle will be illuminated by an intense beam of light, a significant amount of scattered light will be produced. This scattered light can be detected and used to monitor the presence of particles on the reticle and the success of trapping and moving them with the beam. Light will also be scattered from the reticle itself, and it is useful for these two sources of scattered light to be characterized, so that they can be distinguished from one another.

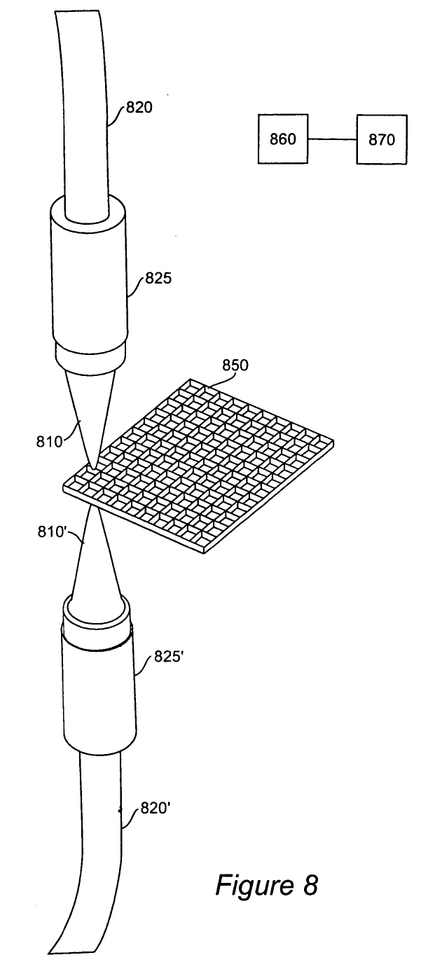

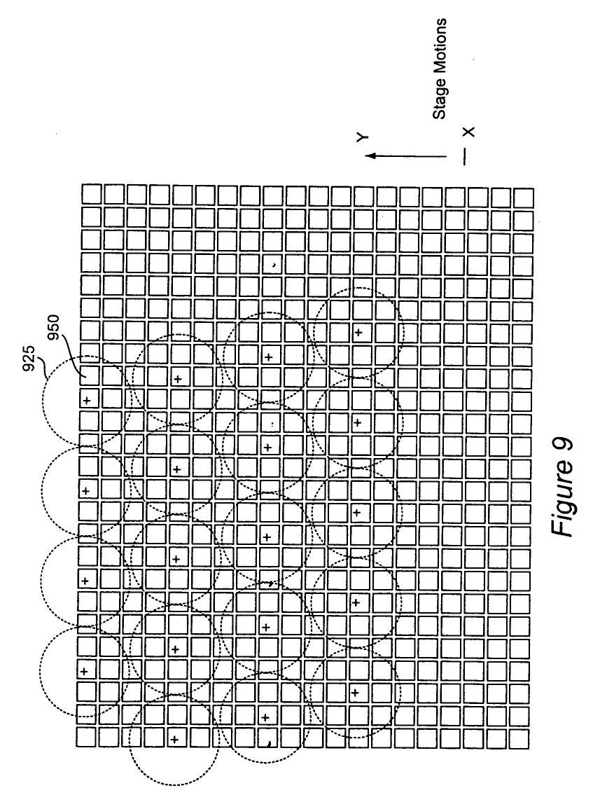

FIG. 8 shows an embodiment of the laser beam system and reticle. Laser light 810 and 810′ is coupled through optical fibers 820, 820′ to lenses 825, 825′ and then focused in the vicinity of the reticle membrane 850. Only a portion of the reticle is shown. The laser source may be a semiconductor laser diode. Laser light scattered from the reticle and any particles present is detected by a detector 860 whose signal is received and processed by a system controller 870. More than one detector may be used. FIG. 9 shows an array of lenses 925 which are optically fiber coupled to laser sources. The laser beams are focused near the reticle membrane 950 such that a stripe of adjacent columns of subfields is processed by the lasers as the retcle is scanned orthogonally to the axis of the laser beams. In this embodiment the laser beams are fixed and the reticle is scanned in a raster pattern in the X direction as the reticle moves steadily in the Y direction. Each optical fiber is coupled to an individual diode laser. Preferably the diode lasers are individual emitters of a semiconductor laser diode array, such as made by Coherent Inc. of Santa Clara, Calif.

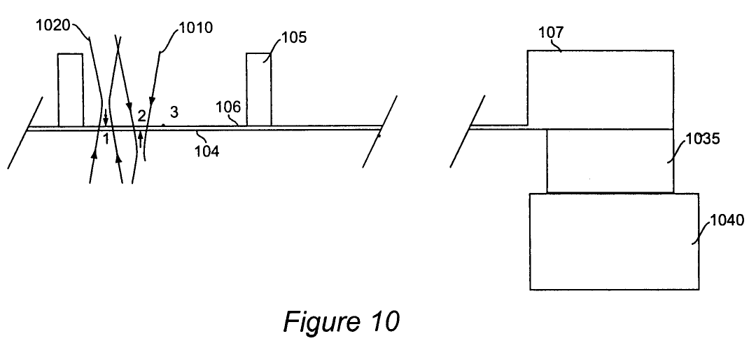

FIG. 10 shows another embodiment of the invention. A force actuator 1040 coupled to the reticle causes the reticle to vibrate at a high frequency or frequencies. In the present version, the force actuator 1040 couples through the reticle chuck 1035, but other arrangements are possible. During a vibration period a particle receives a peak force acting in a direction to weaken the adhesive force binding the particle to the membrane 104. Laser beams 1010 and 1020 simultaneously add to the forces, enhancing the likelihood of particle removal. The removed particles are then trapped by the laser beams, for transfer to the skirt 106 or strut 105 region of the membrane, or the particles on the lower surface of the membrane are driven downward away from the reticle.

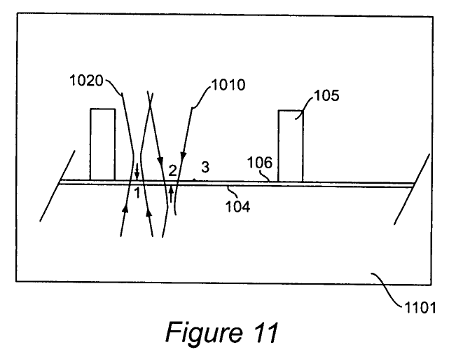

FIG. 11 shows how the present invention can be used in the lithography machine 1101. The laser beams 1010, 1020, which are used for a focused ion beam doping, can be also applied for cleaning a reticle (wafer) 104 as previously described.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. An apparatus, comprising:
a membrane reticle defining a patterned area; and
a laser configured to generate a laser beam focused proximate to the patterned area on the membrane reticle, the laser being configured to create an attractive force that attracts particles on the patterned area of the membrane reticle to the laser beam and to use the attractive force to move the particles away from the patterned area on the membrane reticle.

2. The apparatus of claim 1, wherein the laser is configured to generate the laser beam with an optical axis normal to the membrane reticle.

3. The apparatus of claim 1, wherein wavelength of the laser beam is within the range 1 μm to 5 μm.

4. The apparatus of claim 1, further comprising a membrane holder configured to hold the membrane reticle stationary while the laser beam sweeps the membrane reticle, whereby the attractive force on the particles created by the laser moves the particles away from the patterned area of the membrane reticle during the sweep.

5. The apparatus of claim 1, further comprising a membrane mover configured to move the membrane reticle relative to the laser beam, whereby the attractive force on the particles created by the laser moves the particles away from the patterned area of the membrane when the membrane reticle moves relative to the laser beam.

6. The apparatus of claim 1, further comprising:
a membrane mover configured to move the membrane reticle; and
a laser mover configure to move the laser beam generated by the laser,
whereby both the membrane reticle and laser beam move with respect to one another to effectuate the laser beam sweeping the membrane reticle to remove particles from the patterned area of the membrane reticle.

7. The apparatus of claim 1, wherein the laser beam is configured to have a focal point a predetermined distance from a surface of the membrane reticle, whereby particles on the surface of the membrane reticle are attracted to the focal point.

8. The apparatus of claim 6, wherein the focal point is above the surface of the membrane reticle.

9. The apparatus of claim 6, wherein the focal point is below the surface of the membrane reticle.

10. The apparatus of claim 1, wherein the laser beam is configured to have a focal point substantially at a surface of the membrane reticle.

11. The apparatus of claim 1, further comprising a control system, coupled to the laser, and configured to control the laser to turn on the laser beam when particles are to be removed from the membrane reticle and to turn off the laser beam after the particles have been removed from the membrane reticle.

12. The apparatus of claim 10, wherein the control system is further configured to control the direction of the laser beam.

13. The apparatus of claim 1, wherein the laser is further configured to generate a continuous laser beam during the period when particles are being removed from the membrane reticle.

14. The apparatus of claim 1, wherein the laser beam has a power density ranging from 10⁴ W/cm² to 10⁹W/cm².

15. The apparatus of claim 1, wherein the membrane reticle has a plurality of the patterned areas, the patterned areas being surrounded by non-patterned areas and struts on the membrane reticle.

16. The apparatus of claim 1, further comprising a lithography machine including a source of exposure beam energy means to focus said exposure energy beam at said membrane reticle to produce a patterned exposure beam and means to project said patterned exposure energy beam on a selected location of target.

17. The apparatus of claim 14, further comprising an in-situ cleaning tool, the in-situ cleaning tool comprising said laser configured to generate the laser beam to remove particles from the membrane reticle.

18. The apparatus of claim 1, further comprising a pulsed laser beam generator, the pulsed laser beam generator configured to generate a pulsed laser beam to dislodge particles from the patterned area of the membrane reticle.

19. The apparatus of claim 1, further comprising:
a plurality of the patterned areas on the membrane reticle; and
a plurality of the lasers configured to generate laser beams focused proximate to the plurality of corresponding patterned areas respectively, the plurality of laser beams configured to each create an attractive force that attracts particles illuminated by the laser beams on the corresponding patterned areas to the focal regions of the laser beams and to use the attractive forces to move the particles away from the patterned areas respectively.

20. The apparatus of claim 1, further comprising a detector sensitive to the laser light.

21. An apparatus, comprising:
a reticle defining a patterned area; and
a laser configured to generate a laser beam focused proximate to the patterned area on the reticle, the laser being configured to create an attractive force that attracts particles illuminated by the laser beam on the patterned area of the reticle to the focal region of the laser beam and to use the attractive force to move the particles away from the patterned area on the reticle.

22. A method of cleaning a membrane reticle, comprising the steps of:
generating a laser beam focused proximate to a patterned area on a membrane reticle;
attracting particles on the patterned area of the membrane reticle with the laser beam; and
moving the particles away from the patterned area on the membrane reticle using the attractive force of said laser beam.

23. The method of claim 19, wherein the step of moving the particles away from the patterned area further comprises the steps of:
removing the particles off a surface of the patterned area of the membrane reticle;
moving the removed particles away from the patterned area by controlling the position of the laser beam relative to the patterned area of the membrane reticle.

24. The method of claim 19, wherein the step of moving the particles away from the patterned area further comprises a step of dragging the particles across the patterned area of the membrane reticle by controlling the position of the laser beam relative to the patterned area of the membrane reticle.

25. The method of cleaning a membrane reticle, comprising:
generating a plurality of laser beams focused proximate to patterned areas on the membrane reticle;
attracting particles on the patterned areas of the membrane reticle with said plurality of laser beams; and
moving the particles away from the patterned areas on the membrane reticle using the attractive force of said plurality of laser beams.

26. The method of claim 22, wherein the step of moving the particles away from the patterned area further comprises the steps of:
removing the particles off a surface of the patterned areas of the membrane reticle;
moving the removed particles away from the patterned areas by controlling the position of each of plurality of laser beams relative to the patterned areas of the membrane reticle.

27. The method of claim 22, wherein the step of moving the particles away from the patterned area further comprises the steps of:
removing the particles off a surface of the patterned areas of the membrane reticle;
moving the removed particles away from the patterned area by controlling the position of said membrane reticle relative to the plurality of laser beams.

28. The method of claim 22, wherein the step of moving the particles away from the patterned area further comprises a step of dragging the particles across the patterned areas of the membrane reticle by controlling the position of each of plurality of laser beams relative to the patterned areas of the membrane reticle.

29. The method of claim 19, wherein the step of moving the particles away from the patterned area further comprising a step of applying the pulsed laser beam to dislodge particles from the patterned area.

30. The method of claim 22, wherein the step of moving the particles away from the patterned area further comprising a step of applying the pulsed laser beam to dislodge particles from the patterned area.
